(19) United States
(12) Patent Application Publication
(10) Pub. No.: US 2016/0303972 A1
(43) Pub. Date: Oct. 20, 2016

(54) CHANGING OF THE DRIVING MODE FOR A DRIVER ASSISTANCE SYSTEM

(71) Applicant: AUDI AG, Ingolstadt (DE)

(72) Inventor: Marcus KÜHNE, Beilngries (DE)

(73) Assignee: AUDI AG, Ingolstadt (DE)

(21) Appl. No.: 15/036,709

(22) PCT Filed: Nov. 12, 2014
(86) PCT No.: PCT/EP2014/003026

§ 371 Date: May 13, 2016

(30) Foreign Application Priority Data
Nov. 15, 2013 (DE) 10 2013 019 141.6

(51) Int. Cl. B60K 35/00; B60W 50/08; G05D 1/00

(52) U.S. Cl. CPC B60K 35/00; G05D 1/0088; B60W 50/082

(57) ABSTRACT

A driver assistance system of a motor vehicle has an autonomous driving mode in which the driver assistance system independently performs vehicle guidance including both longitudinal guidance and lateral guidance of the vehicle. A change signal is designed to initiate a change from the autonomous driving mode into another, predetermined driving mode in which a driver of the vehicle is intended to perform at least part of the vehicle guidance in such a way as to make a safe change of the driving mode. For this purpose, the driver assistance system detects driver data, which depend on a posture of at least part of the driver, by a sensor device. When the change signal is received, it is checked whether the driver data satisfy a predetermined safety condition and the driving mode is changed only when the safety condition is satisfied.

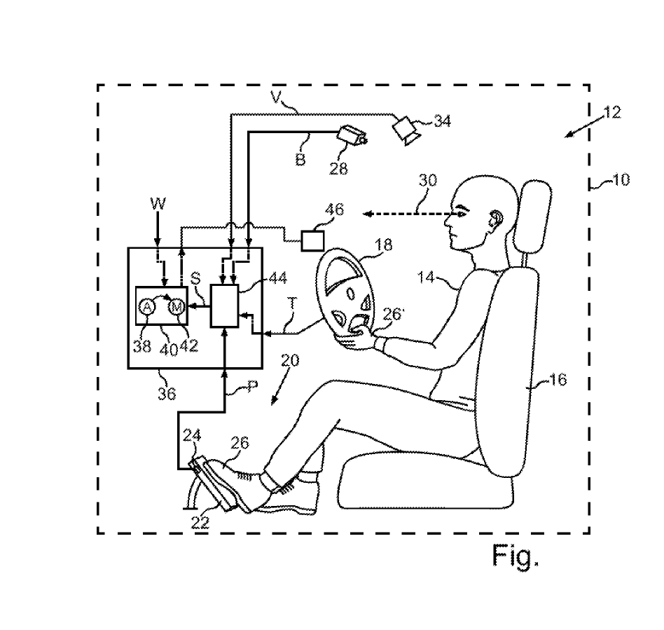

### CROSS REFERENCE TO RELATED APPLICATIONS

This application is the U.S. national stage of International Application No. PCT/EP2014/003026, filed Nov. 12, 2014 and claims the benefit thereof. The International Application claims the benefit of German Application No. 10 2013 019 141.6 filed on Nov. 15, 2013, both applications are incorporated by reference herein in their entirety.

### BACKGROUND

Described below is a motor vehicle having a driver assistance system. The driver assistance system has an autonomous driving mode in which it independently performs vehicle guidance which includes both longitudinal guidance (acceleration and braking) and lateral guidance (steering) of the vehicle. The changing from the autonomous driving mode into another, predetermined driving mode in which a driver of the vehicle is to perform at least part of the guidance of the vehicle is described.

Complete guidance of the vehicle by a driver assistance system is also referred to as piloted driving. A challenge when introducing piloted driving is to transfer control of the vehicle to the driver only when he can also actually assume the control.

DE 2009 050 404 A1 discloses in this regard monitoring the driver continuously during the activated autonomous driving mode and ensuring by warning signals that the driver does not move into a situation from which, in an emergency, he cannot assume control of the vehicle again quickly enough.

DE 10 2006 056 094 A1 also discloses monitoring the presence of the driver on the driver's seat, and in the event of the driver being absent, triggering a self-deactivation function by which controlled forced braking of the vehicle to a stationary state is initiated.

EP 1 790 519 A1 discloses a device for monitoring a steering wheel, which device determines whether a driver of a car has gripped the steering wheel.

A further method for detecting a steering wheel contact is known from DE 10 2011 013 023 A1.

EP 2 371 649 A1 describes a method for determining information relating to the viewing direction of a driver and/or to the position of the driver's hands with respect to the steering wheel. An imaging device which detects the steering wheel and the driver's head is provided for this purpose.

The methods for checking for the driver's presence, which are known from the related art, restrict late to the driver to the extent that even during piloted driving the movement is spatially limited so that a change of driving mode from the autonomous driving mode is safe.

### SUMMARY

Described herein is a driver assistance system that performs a safe change of driving mode from an autonomous driving mode to a driver-controlled mode.

The method described herein serves to operate the driver assistance system of the vehicle. The method is based on the situation in which the driver assistance system automatically performs vehicle guidance, that is to say longitudinal guidance and lateral guidance of the car, in the autonomous driving mode. Furthermore, it is assumed that while the autonomous driving mode is active, the driver assistance system receives a change signal which is designed to initiate, at the driver assistance system, the change from the autonomous driving mode into another, predetermined, driving mode. In other words, the autopilot is to be deactivated by the change signal. In the specified, other driving mode there is provision that a driver of the car carries out at least part of the vehicle guidance, that is to say the longitudinal guidance and/or the lateral guidance.

However, in response to the change signal, the driver assistance system does not switch unconditionally from the autonomous driving mode into the other driving mode. Instead, according to the method described herein, there is provision that the driver assistance system detects driver data, which depend on a posture of at least part of the driver, by a sensor device of the car. When the change signal is received, the driver assistance system then checks whether the driver data satisfy a predetermined safety condition, and the change into the other driving mode is then carried out only when the safety condition is satisfied.

The method has the advantage that the driver can move freely until the change signal is received by the driver assistance system. Only after this is it checked, on the basis of the driver data, whether the driver is ready to assume control of driving.

The motor vehicle described herein includes the driver assistance system and the sensor device. In other words, the sensor device is designed to acquire driver data, which describe a posture of at least part of the driver, that is to say are dependent on the posture, and to transmit the driver data to the driver assistance system. The motor vehicle is designed to operate the driver assistance system according to an embodiment of the method.

In one advantageous development of the method there is provision that the sensor device has a detection device for detecting at least one predetermined hand position. In other words, the sensor device indicates if at least one hand of the driver has assumed a predetermined hand position. The driver data then correspondingly include hand position data of the detection device. The safety condition which is checked before the changing of the driver mode may thus be that one or both hands of the driver is/are arranged on a steering handle of the car. The car can have, for example, a steering wheel or a control lever as a steering handle. In this development, it is therefore ensured, in other words, that the driver keeps his hand or both hands on the steering wheel. The detection device can have, for example, a ToF (Time of Flight) camera which can be arranged, for example, in a roof module of the car and films the steering wheel from there. For the detection of a hand position it is possible to use, for example, the functional library “KINECT” of Microsoft. The use of a ToF camera has the additional advantage that the image data of the ToF camera also includes depth information on the basis of which it is possible to differentiate between, on the one hand, a hand resting on the steering wheel and, on the other hand, a hand which is held over the steering wheel but does not touch the steering wheel.

In another development there is provision that the sensor device has a viewing-direction-detection device for determining a viewing direction of the driver. The driver data correspondingly include viewing direction data of the viewing-direction-detection device. The safety condition in this development is formulated to the effect that the driver must keep his view directed onto a predetermined region in front of the car. In other words, by checking the safety condition it is ensured that the driver has his eyes directed forward and perceives the traffic situation. A sensor system which is suitable for this can be, for example, a viewing-direction-detection device such as is available per se in the related art for so-called eye tracking.

Another development provides that the sensor device has a sensor which is arranged on a pedal of the car and the driver data include contact data of the sensor. In this development, the safety condition may be that a foot of the driver rests on the pedal and/or the driver depresses the pedal with his foot to a predetermined pedal position. The sensor can be configured to the extent that it is designed to signal contact with the pedal by a foot of a driver, wherein as a result of this contact the pedal remains in a position of rest into which it is moved even in the unactivated state, that is to say in the event of it not being depressed by a foot. When such a sensor is provided, the advantage arises that after the changing from the autonomous driving mode into the other driving mode the pedal is not yet activated by the driver, with the result that when the other driving mode is activated, for example, a braking maneuver is not initiated inadvertently if the pedal is the brake pedal. Likewise, unintended acceleration of the car can be avoided in the event of the pedal being the accelerator pedal. The fact that according to the safety condition it is alternatively checked whether the driver depresses the pedal to a predetermined pedal position with his foot, provides the advantage that a stepless transition can be brought about from the vehicle guidance by the driver assistance system in the autonomous driving mode, on the one hand, to the vehicle guidance by the driver in the other driving mode, on the other hand. Which pedal is monitored in conjunction with the checking of the safety condition can be defined by a person skilled in the art, for example, as a function of the type of car.

According to another development, when the safety condition is infringed, that is to say if the driver has not assumed the predetermined posture for the changing of the driving mode, the driver assistance system outputs a message to the driver which specifies which part of the safety condition is not satisfied. The driver can then correspondingly correct his posture. Additionally or alternatively to this, it can also be provided that the message includes an action instruction as to how the posture is to be changed in order to satisfy the safety condition completely. This provides the advantage that the driver can be moved more quickly into the correct posture, which is particularly advantageous, in particular in the case of an emergency shut-down of the autonomous driving mode. The message can be configured, for example, as an announcement or can be effected as a video sequence or by a light symbol.

According to another development, when the safety condition is satisfied the change from the autonomous driving mode into the other driving mode is also not carried out until the driver performs a predetermined initial gesture. For example, there can be provision that the driver triggers the change by tapping on a pedal or by a predetermined rotational movement of the steering wheel. In this context there may be provision that the initial gesture is configured as a zero action, that is to say the initial gesture which is performed does not have an effect on the vehicle guidance itself. For example, the pedal and/or the steering wheel can therefore also remain uncoupled from the actuators for the vehicle guidance to such an extent that the driver can make the initial gesture, that is to say, for example, treading on the pedal or shaking the steering wheel. Only afterwards is the pedal and/or the steering wheel coupled to the corresponding actuators.

Another development provides that when the safety condition is satisfied, the change into the other mode is not performed immediately but instead firstly a transfer countdown is output in the car and the change is performed immediately subsequent to the transfer countdown, wherein the safety condition is checked once more and the condition has to continue to be satisfied. The transfer countdown can be configured, for example, as an announcement, for example by the following announcement: “Transfer in 3-2-1 now.” A graphic transfer countdown can be configured, for example, as a bar graph whose length decreases, wherein the driving mode change then takes place at the length zero.

With respect to the described change signal which triggers the checking of the safety condition, according to one embodiment there is provision that the change signal is generated by an operator control element as a function of activation by the driver. Additionally or alternatively to this it is also possible to provide that when an abort condition applies a control device of the car generates the change signal. For example, the abort condition can state that the car approaches an edge of a zone in which piloted driving is permitted. Another abort condition can state that the traffic situation permits driving at a velocity which is higher than a maximum permitted velocity for the piloted driving.

The motor vehicle has features which have already been described in relation to the developments of the method. For this reason, the corresponding developments of the vehicle are not described here once more.

The motor vehicle may be a car, in particular a passenger car.

### BRIEF DESCRIPTION OF THE DRAWINGS

These and other aspects and advantages will become more apparent and more readily appreciated from the following description of the exemplary embodiment, taken in conjunction with the accompanying drawings of which:

The single FIGURE is a schematic illustration of an embodiment of an automobile interior.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

In the exemplary embodiment described below, the components of the embodiment each represent individual features which are to be considered independently of one another and are therefore also to be considered individually or in some other combination than that shown. Furthermore, the described embodiment can also be supplemented by further features which have already been described.

The FIGURE shows a passenger compartment 12 of a car 10. The car 10 can be, for example, a car, in particular a passenger car. A driver 14 who is seated in a driver's seat 16 is illustrated. A steering wheel 18 is located in front of the driver 14 in the longitudinal direction of the vehicle.

A pedal set of the car 10, of which a single pedal 22 is illustrated in the FIGURE, can be arranged in a footwell 20. The pedal 22 can have a sensor 24 which generates a sensor signal P which signals whether a foot 26 of the driver 14 rests on the pedal 22. In this respect, the driver 14 does not necessarily have to deflect the pedal 22 out of its position of rest with his foot 26. The sensor 24 can be, for example, a pressure sensor which has a higher sensitivity than a resetting device by which the pedal 22 is held in the position of rest in a monostable fashion. The sensor 24 can also be a capacitive sensor. The sensor 24 can also have a plurality of component sensors, with the result that contact of the foot 26 with the pedal 22 is detected over a surface.

A viewing-direction-detection device 28 can be provided for detecting a viewing direction 30 of the driver 14 and for generating viewing direction data B which describe the detected viewing direction 30. The viewing-direction-detection device 28 can, for example, emit an infrared signal and film an eye 32 of the driver 14 in the infrared range, as a result of which a relative position of the iris with respect to the retina of the eye 32 can be evaluated in the infrared image data and an orientation of the optical axis of the eye 32 can be determined therefrom, and this orientation can be output as the viewing direction 30 in the viewing direction data B. The viewing-direction-detection device 28 can also be configured in a manner known per se from the related art.

The passenger compartment 12 can be filmed by a camera 34 which generates the video data with an image of the driver 14. The camera 34 can be, for example, a ToF camera. The camera 34 can be implemented, for example, as a PMD (Photonic Mixing Device) camera.

The steering wheel 18 can have a contact sensor which signals if a hand 26′ or both hands are in contact with the steering wheel 18. The contact sensor indicates contact by a steering wheel signal T. Additionally or alternatively to this, the steering wheel signal T can also signal a rotational movement of the steering wheel 18.

The car 10 can have a driver assistance device 36. The driver assistance device 36 can be implemented, for example, by a control unit. The driver assistance device 36 can have an autonomous driving mode 38 in which the driver assistance device 36 itself drives the car 10 completely, that is to say performs both longitudinal guidance and lateral guidance of the car 10.

If the driver 14 wishes to or is to assume himself the guidance of the car 10 again completely or partially, that is to say wishes to or is to perform the lateral guidance with the steering wheel 18 and the longitudinal guidance with the pedal set in the footwell 20, this can be signaled to the driver assistance device 36 by a change signal W. The change signal W can be received by a control device 40 of the driver assistance system 36 and processed. The control device 40 can be, for example, a program module of the driver assistance system 36.

Before the control device 40 performs a change from the autonomous driving mode 38 into, for example, another driving mode 42 which is defined by the change signal W, the control device 40 checks whether the change from the autonomous driving mode 38 into the other driving mode 42 is safe. The control device 42 can for this purpose check a safety signal S which can be generated by a monitoring device 44 of the driver assistance system 36 and which indicates that the change is safe.

The monitoring device 44 can also be, for example, a program module of the driver assistance device 36. The monitoring device 44 can receive the sensor data P, the video data V, the viewing direction data B and the steering wheel signal T or a portion thereof as driver data and evaluate therefrom whether the change from the autonomous driving mode 38 is safe, and can then signal this by transmitting the safety signal S.

There may be provision that the transfer of the control to the driver 14 takes place only in the event of the monitoring device 44 detecting that the driver 14 has directed his eyes onto the road in front of the car 10, is holding at least one hand 26′ on the steering wheel 18 and has placed a foot 26 on the pedal 22 of the pedal set. As a result of the combined checking by the monitoring device 44, a combination of sensor systems which are present is used to detect and monitor the readiness of the driver 14 to assume control. The described sensor systems for detecting the driver's condition and the transfer of control to the driver 14, which is dependent thereon, makes the switching off of the autonomous driving mode 38 safe for the driver 14. At the change from the autonomous driving mode 38 into the other driving mode 42 it is ensured that the driver 14 has directed his eyes forward and is perceiving the traffic situation, is holding his hand 26′ or both hands on the steering wheel 18 and his feet or at least one foot 26 is positioned on the pedal set.

If it is detected by the monitoring device 44 that the driver 14 does not completely satisfy the safety conditions, a visual, acoustic or audiovisual message can be generated by an output device 46, which can be, for example, a screen in a center console of the car 10 and/or an audio system of the car 10. The indication can clarify to the driver 14 how he has to change his posture, that is to say whether he is still to place a hand 26′ on the steering wheel 18 or is to position his foot 26 on the correct pedal 22 or is to orient his viewing direction 30 in the desired way.

A transfer countdown can also be provided as further protection and/or the changing out of the autonomous driving mode 38 can be triggered by the driver 14 himself in that the driver 14 makes an initial gesture, for example briefly shakes the steering wheel 18 or depresses the pedal 22.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A method for operating a driver assistance system of a motor vehicle having an autonomous driving mode in which the driver assistance system independently performs vehicle guidance including both longitudinal guidance and lateral guidance of the motor vehicle, comprising:
detecting driver data based on a posture of at least part of the driver by a sensor device of the motor vehicle;
receiving a change signal, at the driver assistance system, designating initiation of a change from the autonomous driving mode into another, predetermined driving mode in which a driver of the motor vehicle is intended to perform at least part of the vehicle guidance;
checking, when the change signal is received, whether the driver data satisfy a predetermined safety condition;
changing into the other driving mode only when the safety condition is satisfied; and
outputting, when the safety condition is not satisfied, from the driver assistance system, a message to the driver via an output device, the message at least one of specifying which part of the safety condition is not satisfied and providing an action instruction as to how the posture is to be changed to satisfy the safety condition completely.

12. The method as claimed in claim 11,
wherein the sensor device includes a detection device detecting a predetermined hand position of at least one hand of the driver,
wherein the driver data include hand position data of the detection device, and
wherein the safety condition requires one of one hand and both hands of the driver on a steering wheel of the motor vehicle.

13. The method as claimed in claim 12,
wherein the sensor device further includes a viewing-direction-detection device determining a viewing direction of the driver,
wherein the driver data further include viewing direction data of the viewing-direction-detection device, and
wherein the safety condition further requires that the driver has directed his viewing direction onto a predetermined region in front of the motor vehicle.

14. The method as claimed in claim 13,
wherein the sensor device further includes a sensor arranged on a pedal of the motor vehicle,
wherein the driver data further include contact data of the sensor, and
wherein the safety condition further requires at least one of a foot of the driver on the pedal and depression of the pedal by the foot of the driver to a predetermined pedal position.

15. The method as claimed in claim 14, wherein said changing into the other driving mode is performed only after the safety condition is satisfied and the driver performs a predetermined initial gesture.

16. The method as claimed in claim 15,
further comprising outputting, after the safety condition is satisfied, a transfer countdown in the motor vehicle, and
wherein said changing into the other driving mode is performed subsequent to the transfer countdown provided the safety condition then continues to be satisfied.

17. The method as claimed in claim 16, further comprising generating the change signal by at least one of an operator control element as a function of activation by the driver and a control device when an abort condition applies.

18. The method as claimed in claim 11,
wherein the sensor device has a viewing-direction-detection device determining a viewing direction of the driver,
wherein the driver data include viewing direction data of the viewing-direction-detection device, and
wherein the safety condition requires that the driver has directed his viewing direction onto a predetermined region in front of the motor vehicle.

19. The method as claimed in claim 11,
wherein the sensor device has a sensor arranged on a pedal of the motor vehicle,
wherein the driver data include contact data of the sensor, and
wherein the safety condition requires at least one of a foot of the driver on the pedal and depression of the pedal by the foot of the driver to a predetermined pedal position.

20. The method as claimed in claim 11, wherein said changing into the other driving mode is performed only after the safety condition is satisfied and the driver performs a predetermined initial gesture.

21. The method as claimed in claim 11,
further comprising outputting, after the safety condition is satisfied, a transfer countdown in the motor vehicle, and
wherein said changing into the other driving mode is performed subsequent to the transfer countdown provided the safety condition then continues to be satisfied.

22. The method as claimed in claim 11, further comprising generating the change signal by at least one of an operator control element as a function of activation by the driver and a control device when an abort condition applies.
